(19) United States
(12) Patent Application Publication
(10) Pub. No.: US 2022/0199284 A1
(43) Pub. Date: Jun. 23, 2022

(54) INSULATING WIRE WITH HIGH THERMAL RESISTANCE AND RESISTANT TO PARTIAL DISCHARGES AND WIRE DRAWING PROCESS

(71) Applicant: WEG Equipamentos Eletricos S.A., Jaragua do Sul (SC) (BR)

(72) Inventors: Renato Lourenco, Jaragua do Sul (SC) (BR); Cristiane Medeiros, Jaragua do Sul (SC) (BR); Waldiberto de Lima Pires, Jaragua do Sul (SC) (BR); Hugo Gustavo Gomez Mello, Jaragua do Sul (SC) (BR)

(21) Appl. No.: 17/554,303

(22) Filed: Dec. 17, 2021

Related U.S. Application Data
(60) Provisional application No. 63/129,922, filed on Dec. 23, 2020.

(51) Int. Cl. H01B 7/02; H01B 13/00; H01B 13/06; H01B 13/16

(52) U.S. Cl. CPC H01B 7/0225; H01B 13/16; H01B 13/065; H01B 13/0016

(57) ABSTRACT

A manufacturing of wires with optimized insulation properties, providing an insulating wire and the wire drawing process for producing it. The wire enamel has three layers: base layer (2), middle layer (3) and top layer (4), wherein these layers wrap around the conducting wire (1) in this order. The wire drawing process is carried out by a) Primary drawing; b) Final drawing and c) Enameling process carried out in line, wherein the enameling is conducted preferably with a specific number of dies for each layer. The process and composition conditions of the wire allowed to provide a triple layer wire that presents high resistance to partial discharges, high thermal class and high resistance to abrasion, thus, increasing the service lifetime of the wire in demanding motor applications when high thermal, high mechanical and high electrical resistance are required.

### CROSS-REFERENCE TO RELATED APPLICATIONS

This application claims the benefit of U.S. Provisional Application No. 63/129,922 filed on Dec. 23, 2020, the contents of which is incorporated herein by reference.

### TECHNICAL FIELD

The wider technical field of the present disclosure is related to the manufacturing of cables, conductors, insulators, and the selection of materials for their conductive, insulating or dielectric properties, more specifically the field is related to the disposition of insulation in these components, and even more specifically for dispositions comprising two or more layers of insulation having different electrical, mechanical, chemical and/or thermal properties.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In motor applications supplied for smoke extraction segment there are strict technical requirements which must be proven to be satisfied by the machine in order to guarantee its operational efficiency in the event of an accident, such as meeting the operating condition at room temperature equal to or greater than 400° C. for 2 hours.

When such applications are carried out in conjunction with variable speed drives (static frequency converters), in addition to the previously mentioned thermal requirements, there are additional dielectric stresses potentially harmful to the motor insulation system, due to the phenomena of transmission lines and traveling waves that can degrade the winding in an accelerated manner, thus reducing its service life, especially when the motor is powered by long cables. Currently available solutions for this kind of application are effective for one of the above-mentioned effects only: wires can withstand only stringent thermal requirements or only stringent electrical requirements, and usually comprising the most varied insulating materials.

Some documents include developments related to the enameling process of wires, but there are still some technical shortcomings mainly related to the balance of electrical properties with thermal properties in the product.

U.S. Pat. No. 5,654,095 was a pioneer in the development of enameled wires resistant to partial discharges comprising a conductor, a continuous, concentric and flexible uniform coat of base insulation material superimposed on the conductor and an essentially continuous, concentric and uniform pulsed voltage surge shield overlaying the coat of base insulation material. U.S. Pat. No. 5,654,095 although citing possible components like the present invention, it does not disclose a triple layer structure and does not disclose the proportionality relationship between the quantity of each layer so that it is possible to optimize the electrical and thermal effects concurrently. In addition, there is no mention of die sets and drawing process parameters that would allow the production of a wire as described in the present invention.

US20130099621 provides an electrical conductor with an electrical insulation system surrounding the conductor, the insulation includes a first insulation layer surrounding the conductor and a second insulation layer surrounding the first insulation layer. The second insulation layer includes a second polymer and a second filler in the form of chromium oxide (Cr2O3), iron oxide (Fe2O3), or a mixture of chromium oxide and iron oxide, wherein the first insulation layer includes a first polymer and a first filler including dispersed nanoparticles.

It appears that, in this case, both layers are loaded with inorganic particles, therefore there is no third layer as described in the present invention. Moreover, in the present invention the inorganic filler does not include chromium oxide (Cr₂O₃) or iron oxide (Fe₂O₃). However, the aim of US20130099621 is to provide the resistance against partial discharges in the electrical insulation system, without any technical solution for improving thermal and mechanical properties of the wire at the same time.

WO2013/133334 provides an insulated wire having a conductor, a foamed insulating layer, and a non-foamed filling layer on the outer periphery of the foamed insulating layer, wherein the filling layer contains a partial discharge resistant substance. This insulated wire has high partial discharge inception voltage, partial discharge resistance, heat resistance and wear resistance (scratch resistance).

The present invention does not use the foaming process in any of the steps of the wire drawing process, precisely to avoid the presence of bubbles, which are the effect of the defoaming process on the enameled wire.

WO2003056575 discloses a magnet wire including at least one conductor and at least one insulating layer, said insulating layer including a composition comprising: (a) at least a polymeric resin; (b) at least a fluorinated organic filler; and (c) at least a non-ionic fluorinated surfactant. Said magnet wire is endowed with high resistance to pulsed voltage surges. However, it specifies the use of fluorinated organic additives in the enamel varnish, a requirement that does not exist in the present invention, due to the fact that the solution is focused on the layering of the insulating enamel and not essentially on the type of inorganic additive used.

US20050042451 discloses an improved magnet wire for motors coupled to speed controllers with higher resistance to voltage peaks and its manufacturing process, with a 200° C. thermal class product with copper or aluminum conductor, with an insulating system of polyesterimide polymers and overcoat of modified amideimide, being the product characterized by useful life more than 100 times longer than the one of the normal 200° C. class magnet wire. In preferable embodiment the desired thickness of an insulating base coat varnish comprising a mixture of polyesterimide and polyglycolylurea covering the conductor core, and a desired thickness of an amideimide resin overcoat varnish.

The amideimide resin of US20050042451 is modified through the incorporation of titanium dioxide and silica metal oxides to withstand high temperature, corona effect and presence of ozone during voltage undulatory pulses. However, there is no third layer as described in the present invention, so that the technical effects of equilibrium cannot be achieved in the abovementioned document for at least one reason: The addition of nanoparticulate material specifically to the middle layer aims to provide an increase in resistance to partial discharges, since the interface between the polymeric material and the additive acts as a jumping point for charge loaders, and is further protected by the cover layer, increasing shear resistance and minimizing external effects, which does not occur in US20050042451 since the layer with additives is unprotected. Moreover, the present invention relates to a wire with thermal class 240° C., significantly exceeding the thermal class of the wire disclosed by US20050042451.

For at least the abovementioned reason, the present invention is not disclosed in the state of the art and would not be considered obvious for a person skilled on the art, since none of the aforementioned documents is able to optimize the enameling process in order to guarantee the desired properties of the insulated wire, which are high resistance to partial discharges while maintaining a high thermal resistance and a high mechanical resistance, therefore increasing the lifetime of the wire.

### SUMMARY OF THE INVENTION

The invention is related to the manufacturing of wires with optimized insulation properties, providing an insulating wire and the wire drawing process to produce this insulating wire. The wire is insulated with three layers: base layer (2), middle layer (3) and top layer (4), wherein these layers wrap around the conducting wire (1) in this order. The wire manufacturing process comprises the following steps: a) Primary drawing; b) Final drawing and c) enameling. These steps are carried out in line and the enameling is conducted preferably with a specific number of dies for each layering. This process guarantees a wire with a triple layer enamel that provides high resistance to partial discharges, a high thermal class and high resistance to abrasion, thus, increasing the service lifetime of the wire in demanding motor applications when high thermal, high mechanical and high electrical resistance are required.

### BRIEF DESCRIPTION OF THE DRAWINGS

In the drawings:

FIG. 1 illustrates the constructive configuration of the new wire (N) with three layers of insulation in comparison with a standard commercial wire (Std) with a two-layer enamel.

FIG. 2 illustrates the average values of the disruptive voltage of a standard commercial wire (Std) compared to the new wire (N) of the present invention.

FIG. 3 illustrates the partial discharge accelerated life test results of a standard commercial wire (Std) compared to the new wire (N) of the present invention.

FIG. 4 illustrates the probability density plot for the Weibull distribution of the samples subjected to the partial discharge accelerated life test.

FIG. 5 illustrates the lifetime of the samples of a standard commercial wire (Std) and the new wire (N) of the present invention as a function of temperature.

FIG. 6 illustrates the probability density plot for the Weibull distribution of the samples subjected to thermogravimetry test (TGA).

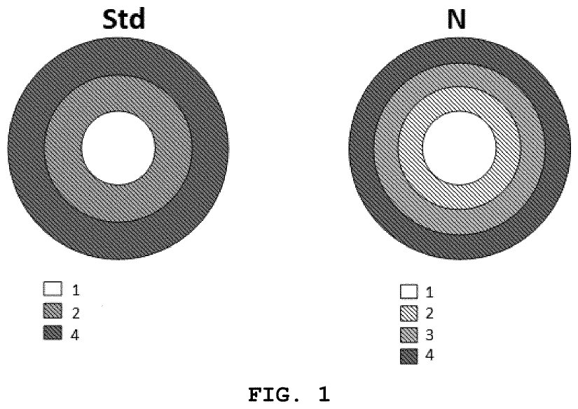

### DETAILED DESCRIPTION OF THE INVENTION

In the following description, for the purpose of explanation, numerous specific details are set forth in order to provide a thorough understanding of the present disclosure. It will be apparent, however, that embodiments may be practiced without these specific details. Embodiments are disclosed in sections according to the following outline:

The present invention comprises a triple enameled magnetic wire, that is a wire whose insulation consists of three insulating layers. The three insulating layers are nominated as base layer (2), middle layer (3) and top layer (4), wherein these layers wrap around the conducting wire (1) in this order.

The conducting wire (1) is made of a conductive material. Examples of suitable materials include, but are not limited to, aluminum, copper, brass, silver, etc. In one preferable embodiment the said conducting wire (1) is made by aluminum, preferably made by an aluminum alloy, most preferably made by a 1350 alloy according to ASTM B-236.

The base layer (2) is made by an organic material, co-polymer, or blend comprising at least one polymer chosen from: polyamideimide, amideimide, polyester, polyesterimide, polyimide polysulfone, polyurethane. Thermal robustness is mainly related to the base layer (2).

The middle layer (3) comprises an organic material as a polymeric matrix, made by an organic material, co-polymer, or blend comprising at least one polymer chosen from: polyamideimide, amideimide, polyester, polyesterimide, polyimide polysulfone, polyurethane; and an additive in the form of inorganic particles dispersed in the polymeric matrix. Examples of inorganic particles include, but are not limited to, zinc oxide, titanium dioxide, barium titanate, silicon dioxide, aluminium oxide, etc.

The middle layer (3) plays a role like that of an electromagnetic shield for the magnetic wire, reducing the electric field acting on the dielectric coverage of the conductors and significantly attenuating the incidence of the Corona Effect in the windings.

The top layer (4) is made by an organic material, co-polymer, or blend comprising at least one polymer chosen from: polyamideimide, amideimide, polyester, polyesterimide, polyimide polysulfone, polyurethane. The top layer (4) is applied over the middle layer (3), which, in turn, is applied over the base layer (2) which, in turn, is applied directly over the conductor (1). The top layer (4) further improves the wire's smoothness and shear resistance.

The addition of nanoparticulate material to the middle layer (3) of the wire aims to provide an increase in resistance to partial discharges, since the interface between the polymeric material and the additive acts as a jumping point for charge loaders, facilitating the dissipation of the generated charge by partial discharge. The addition of the nanoparticulate material and the ordered constructive shape of the layers also changes the thermal property of the material, also for dissipative phenomena.

The wire manufacturing process comprises the following steps:

(A) Primary drawing;

(B) Final drawing;

(C) Enameling process.

The primary drawing step (A) is conducted to reduce the wire diameter, by successive passes through the wire drawing dies until getting the desired dimension. Aluminum wire rods typically present a diameter between 8 and 10 mm. After the primary drawing process, the wire typically presents 15 to 25% of the original diameter. Such reduction must be evaluated according to the type of material used, as well as in relation to the final use of the wire, which may require a smaller or larger dimension in order to avoid the formation of defects and distortions in the material in the final stage.

The final drawing (B) further reduces the wire diameter around 1 to 5 times the input diameter. Such reduction must be evaluated according to the type of material used, as well as in relation to the final use of the wire, which may require a smaller or larger dimension in order to avoid the formation of defects and distortions in the material in the final stage.

The enameling process (C) comprises the application of several insulating layers by means of successive passages of the wire through enameling dies, where each layer of varnish, deposited through the passage in the die, passes through the oven to cure, until reaching the desired insulation dimension.

In one preferential embodiment of the invention, a rod made by conductive material, such as copper or aluminum, is subjected to the wire drawing process in order to provide the triple enameled magnetic wire, wherein the base layer (2) is made of polyimide, the middle layer (3) is made of polyamideimide with dispersed titanium dioxide and the top layer (4) is made of polyamideimide.

The wire typically reaches final diameters between 0.35 and 1.50 mm, preferably between 0.50 and 1.32 mm. The line speed typically lies between 50 and 200 m/min. The oven temperature in the final drawing stage typically varies between 500° C. and 600° C.

The machine preferred parameters used in the drawing process considering each final diameter were divided into temperature parameters for each zone. The wire drawing and enameling processes can be accomplished by e.g. two annealing zones followed by one curing zone, which by its turn it followed by two catalyst zones.

In one preferential embodiment of the invention, the enameling process comprises successive passages of the wire through enameling dies, where each layer of varnish, deposited through the passage in the die, passes through the oven to cure, until reaching the desired insulation dimension. The base layer (2) typically consists of 10 to 50% of the total insulation increase. The middle layer (3) consists of 50 to 90% of the total insulation increase. The top layer (4) consists of up to 20% of the total insulation increase. The thermal, mechanical and electrical characterization seeks to assess the impact of the additive and the construction of the insulating layers on the performance of the wire in question from different perspectives.

In view of that, most of the characterizations were comparatively done with an international standard magnetic wire of the type MW35 per NEMA MW 1000(Std). In both systems the insulating coating has multiple layers.

In the case of the standard wire (Std), the insulating cover consists of a base layer and a top layer. The top layer comprises an organic material, for example, polyamideimide. The base layer also comprises an organic material, for example, polyesterimide. The top layer is applied over the base layer which, in turn, is applied over the conductor, as presumed by the state of the art.

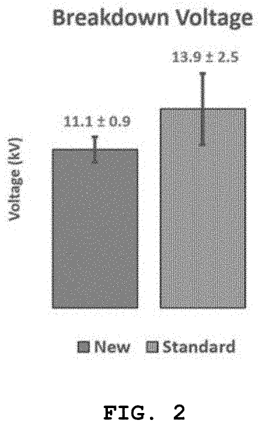

The results of average values for the disruptive voltage for the wires refer to a grade 2 (heavy built) wire in both cases, the wire diameter being 1.320 mm. The referred average values are summarized graphically in FIG. 2, wherein the specified value is the minimum value required for the wire to be considered suitable for use in the manufacture of electric motors according to recognized international standards of magnet wires.

Considering the respective standard deviations of disruptive voltage results, the standard wire (Std) has an average value of 13.9±2.5 and the new wire (N) has an average value of 11.1±0.9. In view of this, statistically considering the average values, it is possible to establish approximately a range of 11-17 kV for the disruptive voltage of a Standard wire (Std) and a range of 10-12 kV for the new wire (N). It is also noticed that both wires far exceed the minimum disruptive voltage required by international standards of magnet wires, that is 5 kV in this case.

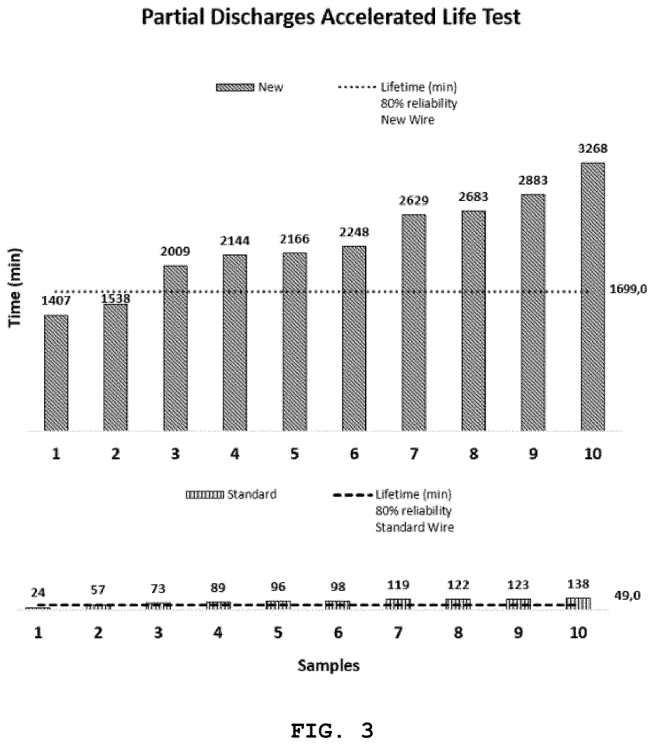

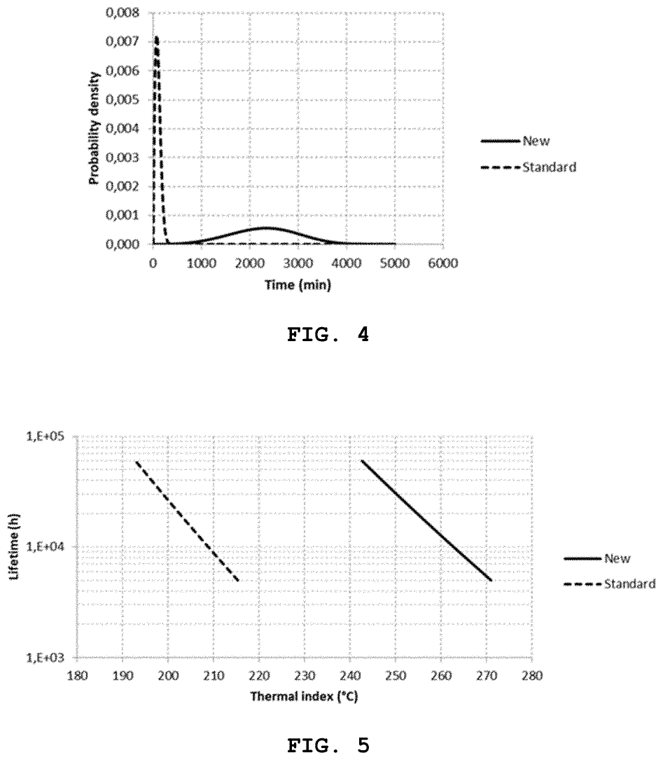

Experimental results show that the disruptive voltage presented by the new wire is normally well above the specification criteria from international standards as previously illustrated. The failure times from sinusoidal voltage endurance test for 10 samples of each wire are shown in FIG. 3, as well as the average statistical lifetime obtained by the two-parameter Weibull distribution, in FIG. 4.

It was observed that the accelerated lifetime of the new wire is approximately 35 times longer than the accelerated lifetime of the standard wire considering the statistical average. The performance gain verified in this case is expected because of the dissipative capacity generated by the addition of inorganic nanoparticles in the new wire. The absence of the additive causes discharges to occur directly in the polymeric chains of the insulating material, favoring the fission of the chains and, in turn, the abrupt electrical erosion of the insulator.

The Weibull distribution parameters for the accelerated life test are scale factor (k) and shape factor (β). In this case, for the new wire sample, the scale factor (k) was about 2550 min and the shape factor (β) was about 4 and for the standard wire sample the scale factor (k) was about 110 min and the form factor (β) was 2, wherein the statistical time corresponding to the occurrence of about 60% of failures.

The density of probability of failure plot resulting from the accelerated life test is shown in FIG. 4. It is noted that the standard wire has a much more abrupt failure mechanism, while the failure mechanism of the new wire evolves gradually, extending over time. This explains the higher scale factor presented by the new wire in comparison to the standard wire in the accelerated life test. This behavior is consistent with the ease of dispersion of charges provided by the addition of nanoparticles in the new wire.

In contrast, in the case of the standard wire, the energy generated by the partial discharges acts directly on the polymeric chains of the insulator, promoting their rupture and causing the electrical treeing that culminates in the failure.

The evaluation of thermal degradation followed the ASTM E1641 and E1877 standards for calculating the thermal index (TI), considering the mass loss equal to 10%, according to the international standard IEC 60216-2, through thermogravimetric analysis (TGA). The time criterion of 20,000 hours follows the recommendation of UL Standard for Safety for Systems of Insulating Materials—General, UL 1446.

The results related to the parameters of kinetic degradation and the thermal index of the samples shows that, for the new wire sample, activation energy (Ea) and frequency factor (Z) were about 21 kJ/mol and about 30 l/s, respectively, culminating in a Thermal index (TI) of about 255° C. For the standard wire sample, activation energy (Ea) and frequency factor (Z) were about 21 kJ/mol and about 36 l/s, respectively, culminating in a Thermal index (TI) of about 200° C. The Activation energy (Ea) in this context represents the minimum amount of energy that is required to trigger the chemical degradation of the enamel.

Another aspect that contributes to the greater durability of the new wire compared to the standard wire in the accelerated life test is the higher thermal index of the new wire. As the twisted pair samples are subjected to a relatively high temperature in the life test (120° C.), the new wire suffers less than the standard wire during the accelerated life test. Although thermal stress has lower impact than electrical stress in this case, the contribution of both should be considered as active degradation agents in the test.

The pre-exponential factor (Z) is also known as a temperature-dependent frequency factor, once it represents the molecular dynamics of the system. Dimensionally, the frequency factor of the new wire sample is about a thousand times smaller than that of standard wire sample. This shows that the frequency of collisions among the molecules of the new wire is lower than that of the standard wire suggesting a higher stability for the new wire that guarantees its higher thermal class. Under the same heating conditions, this system remains more stable, raising the failure temperature by about 50° C.

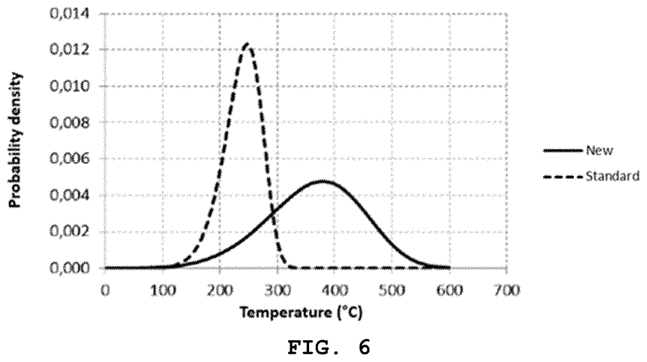

The lifetime over temperature of the wire samples are shown in FIG. 5. The quality improvement of the new wire sample is evidenced once again by the two-parameter Weibull Distribution, in FIG. 6. The higher the shape factor (β) value, the smoother the fault distribution over the temperature. The influence of the scale factor (k) is directly proportional to the failure speed.

For the new wire sample, the scale factor (k) was about 400° C. and the shape factor (β) was about 5, and for the standard wire sample the scale factor (k) was about 250° C. and the scale factor (β) was about 8. The peak of failure occurs in about 380° C. for the new wire sample and in about 250° C. for the standard wire sample.

The graphical evaluation shown in FIG. 6 reveals the simultaneous interference of the two Weibull parameters for each sample. The new wire sample shows a narrower distribution plot indicating a more punctual failure mechanism.

The new wire sample not only showed a more gradual behavior in terms of thermal variation in the probability density plot, but also an improvement of about 130° C. in the failure temperature.

What is claimed is:

1. An insulating wire, comprising:
a conducting wire (1)
a base layer (2)
a middle layer (3)
a top layer (4),
wherein the layers wrap around the conducting wire (1) in an order comprising the base layer wrapping the conducting wire, followed by the middle wrapping the base layer and the top layer wrapping around the middle layer.

2. The wire according to claim 1, wherein the conducting wire (1) is made of a conductive material comprising at least one material chosen from: aluminum, copper, brass or silver.

3. The wire according to claim 2, wherein the conducting wire (1) is made of copper or aluminum.

4. The wire according to claim 1, wherein the base layer (2) is made of a polymer, co-polymer, or blend comprising at least one polymer selected from the group consisting of: polyamideimide, amideimide, polyester, polyesterimide, polyimide, polysulfone and polyurethane.

5. The wire according to claim 4, wherein the base layer (2) is made of polyimide.

6. The wire according to claim 1, wherein the middle layer (3) is made of a polymer, co-polymer, or blend comprising at least one polymer chosen from the group consisting of: polyamideimide, amideimide, polyester, polyesterimide, polyimide, polysulfone and polyurethane, and an additive in the form of inorganic particles dispersed in the polymeric matrix.

7. The wire according to claim 6, wherein the middle layer (3) is made of polyamideimide with titanium dioxide.

8. The wire according to claim 6, wherein the additive in the form of inorganic particles is selected from the group consisting of: zinc oxide, titanium dioxide, barium titanate, silicon dioxide and aluminum oxide.

9. The wire according to claim 1, wherein the top layer (3) is made of a polymer, co-polymer, or blend comprising at least one polymer selected from the group consisting of: polyamideimide, amideimide, polyester, polyesterimide, polyimide, polysulfone and polyurethane.

10. The wire according to claim 9, wherein the top layer (3) is made of polyamideimide.

11. The wire according to claim 1, wherein a proportion of a layer thickness is approximately 10 to 50% base layer (2), 50 to 90% middle layer (3) and up to 20% top layer (4).

12. An insulating wire drawing process, comprising the steps of:
a) primary drawing;
b) final drawing; and
c) enameling process.

13. The wire drawing process according to claim 12, wherein at each step a), b) and c), multiple annealing zones are followed by one or more curing zones, which in turn is followed by multiple catalyst zones.

14. The wire drawing process according to claim 13, wherein at each step a), b) and c), two annealing zones are followed by one curing zone, which in turn is followed by two catalyst zones.

15. The insulating wire drawing process according to claim 12, wherein the enameling process is conducted with a specific number of dies where each layer of varnish, deposited through a passage in the die, passes through an oven to cure, until reaching a desired insulation dimension.

16. The insulating wire drawing process according to claim 12, wherein the enameling process is conducted with a number of dies so that the base layer (2) consists of 10 to 50% of a total insulation increase, the middle layer (3) consists of 50 to 90% of the total insulation increase and the top layer (4) consists of up to 20% of the total insulation increase.
